(19) United States
(12) Patent Application Publication
(10) Pub. No.: US 2009/0161292 A1
(43) Pub. Date: Jun. 25, 2009

(54) LAMINATED CERAMIC CAPACITOR

(75) Inventor: Thomas Aquinas KIM, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/246,685

(22) Filed: Oct. 7, 2008

(30) Foreign Application Priority Data
Dec. 20, 2007 (KR) 10-2007-134229

(51) Int. Cl. H01G 4/12

(52) U.S. Cl. 361/321.2

(57) ABSTRACT

A laminated ceramic capacitor includes a ceramic body having a structure in which a plurality of dielectric sheets are laminated; a first external electrode formed outside the ceramic body; at least two second external electrodes formed outside the ceramic body, separated from the first external electrode and having a polarity that is different from that of the first external electrode; a first internal electrodes formed on one surface of at least one laminated dielectric sheet; and at least two second internal electrodes respectively connected to the at least two second external electrodes through a lead, the second internal electrodes forming capacitive coupling with the first internal electrode, having the at least one dielectric sheet therebetween.

### CROSS-REFERENCE TO RELATED APPLICATIONS

This application claims the priority of Korean Patent Application No. 2007-134229 filed on Dec. 20, 2007, in the Korean Intellectual Property Office, the disclosure of which is incorporated herein by reference.

### BACKGROUND OF THE INVENTION

1. Field of the Invention

The present invention relates to a laminated ceramic capacitor, and more particularly, to a laminated ceramic capacitor, which has a structure in which a plurality of laminated ceramic capacitors are arranged so as to achieve a high degree of integration and miniaturization.

2. Description of the Related Art

A capacitor is a device that stores electricity, and includes two facing electrodes. When a voltage is applied to the capacitor, electric charges are accumulated in the respective electrodes. When a direct current (DC) voltage is applied to the capacitor, a current flows in the capacitor during accumulation of electric charges, whereas it does not flow after the accumulation of the electric charges. When an alternating current (AC) voltage is applied to the capacitor, polarities of the electrodes are alternated so that an AC continuously flows through the capacitor.

According to kinds of dielectrics provided between electrodes, capacitors may be classified into various types including an aluminum electrolytic capacitor, a tantalum capacitor, a ceramic capacitor, a laminated ceramic capacitor and a film capacitor. The aluminum electrolytic capacitor includes aluminum electrodes, and a thin oxide layer is provided between the aluminum electrodes. The tantalum capacitor uses tantalum as an electrode material. The ceramic capacitor uses a dielectric having a high dielectric constant such as titanium-barium between electrodes. The laminated ceramic capacitor uses a multi-layered dielectric of a high dielectric constant between electrodes. The film capacitor uses a polystyrene film as a dielectric between electrodes.

Particularly, the laminated ceramic capacitor has excellent temperature and frequency characteristics and can be implemented in a small size. For this reason, the laminated ceramic capacitor is being widely applied to various fields such as high-frequency circuits.

FIG. 1 is a cross-sectional view of a related art laminated ceramic capacitor 10.

In the related art laminated ceramic capacitor 10, a plurality of dielectric sheets 11 are laminated on top of each other to form a lamination structure. External electrodes 14 and 15 having opposite polarities are formed outside the lamination structure. Internal electrodes 12 and 13 alternately laminated in the lamination structure may be connected to the external electrodes 14 and 15, respectively.

The internal electrodes 12 and 13 alternately formed between the dielectric sheets 11 are connected to each have a different polarity, thereby forming capacitive coupling. Thus, the laminated ceramic capacitor has a capacitance value.

A general electronic component employs an arrangement of a plurality of laminated ceramic capacitors and thus, research is ongoing to reduce its size.

### SUMMARY OF THE INVENTION

An aspect of the present invention provides a laminated ceramic capacitor that has a structure in which a plurality of laminated ceramic capacitors are arranged so as to achieve a high degree of integration and miniaturization.

According to an aspect of the present invention, there is provided a laminated ceramic capacitor including: a ceramic body having a structure in which a plurality of dielectric sheets are laminated; a first external electrode formed outside the ceramic body; at least two second external electrodes formed outside the ceramic body, separated from the first external electrode and having a polarity that is different from that of the first external electrode; a first internal electrode formed on one surface of at least one laminated dielectric sheet; and at least two second internal electrodes respectively connected to the at least two second external electrodes through a lead, the second internal electrodes forming capacitive coupling with the first internal electrode, having the at least one dielectric sheet therebetween.

The first external electrode may be connected to an external ground plane.

The second external electrodes may include three second external electrodes. The first external electrode and the second external electrodes may be formed on side surfaces of the ceramic body to face each other, the side surfaces being formed in a direction in which the dielectric sheets are laminated.

The second internal electrodes respectively connected to the second external electrodes may have the same area.

The first external electrode and the second external electrodes may be formed on side surfaces of the ceramic body, the side surfaces being formed in a direction in which the dielectric sheets are laminated.

The first external electrode and the second external electrodes each may have portions respectively extending to a top surface and a bottom surface of the ceramic body.

The first internal electrode may include a plurality of first internal electrodes formed on the respective different dielectric sheets, and the laminated ceramic capacitor may further include a conductive via passing through the dielectric sheets between the first internal electrodes to connect the first internal electrodes respectively formed on the different dielectric sheets.

The conductive via may be separated from the at least two second internal electrodes on the dielectric sheet at the same distance.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a related art laminated ceramic capacitor;

FIG. 2 illustrates a first internal electrode and a second internal electrode in a laminated ceramic capacitor according to an embodiment of the present invention; and

FIG. 3 is an exploded perspective view of a laminated ceramic capacitor according to another embodiment of the present invention.

### DETAILED DESCRIPTION OF THE PREFERRED EMBODIMENT

Exemplary embodiments of the present invention will now be described in detail with reference to the accompanying drawings.

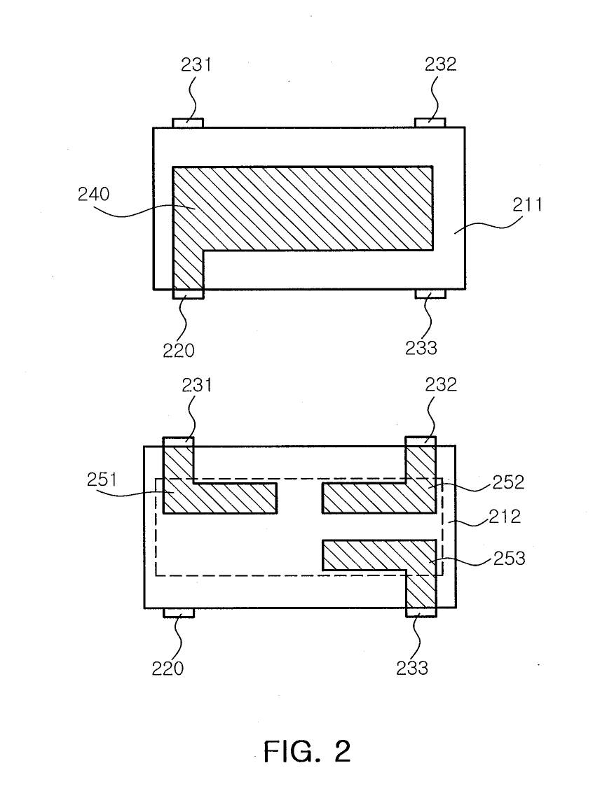

FIG. 2 illustrates a first internal electrode and a second internal electrode in a laminated ceramic capacitor according to an embodiment of the present invention.

Referring to FIG. 2, the laminated ceramic capacitor according to the current embodiment includes a plurality of dielectric sheets 211 and 212 (hereinafter, respectively referred to as first and second dielectric sheets), a first external electrode 220, second external electrodes 231, 232 and 233, a first internal electrode 240 and second internal electrodes 251, 252 and 253.

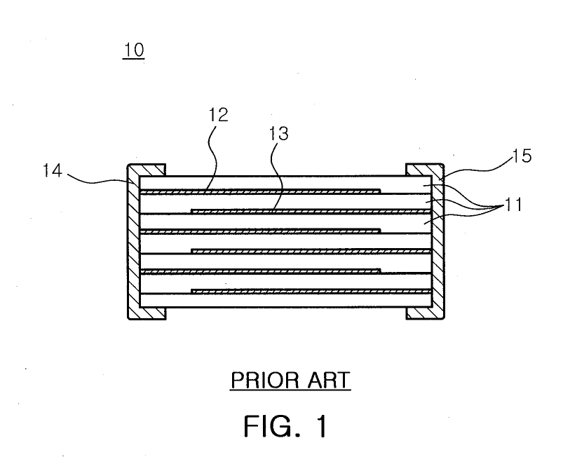

The first and second dielectric sheets 211 and 212 may be laminated to form a ceramic body. In detail, the first internal electrode 240 may be formed on the first dielectric sheet 211, the second internal electrodes 251, 252 and 253 may be formed on the second dielectric sheet 212, and then the first dielectric sheet 211 and the second dielectric sheet 212 may be laminated on top of each other. In FIG. 1, only two dielectric sheets 211 and 212 are illustrated. However, the present invention is not limited thereto, and a plurality of dielectric sheets may be laminated to form the ceramic body of the laminated ceramic capacitor.

The first and second dielectric sheets 211 and 212 each may be a ceramic sheet having a predetermined dielectric constant.

The first external electrode 220 may be formed on a side surface of the ceramic body in a lamination direction in which the first and second dielectric sheets 211 and 212 are laminated. The first external electrode 220 may extend to a top surface and a bottom surface of the ceramic body, so that contact can be facilitated in mounting the laminated ceramic capacitor according to the current embodiment on, e.g., a substrate. According to the current embodiment, the first external electrode 220 may be formed on a surface of the ceramic body by using a conductive material.

The second external electrodes 231, 232 and 233 may be formed on side surfaces of the ceramic body in the lamination direction of the first and second dielectric sheets 211 and 212. The second external electrodes 231, 232 and 233 each may extend to the top surface and the bottom surface of the ceramic body, so that contact can be facilitated in mounting the laminated ceramic capacitor according to the current embodiment on, e.g., a substrate.

According to the current embodiment, three second external electrodes 231, 232 and 233 may be formed.

According to the current embodiment, the first external electrode 220 and the second external electrodes 231, 232 and 233 may be formed adjacent to both ends of the facing side surfaces of the ceramic body. A location of each of the first and second external electrodes 220, 231, 232 and 233 may be varied according to a location of a pad formed at, e.g., a substrate on which the laminated ceramic capacitor is to be mounted.

The first internal electrode 240 having a predetermined area may be formed on one surface of the first dielectric sheet 211 of the ceramic body.

The first internal electrode 240 may be connected with the first external electrode 220 through a lead. According to the current embodiment, if the first external electrode 220 is connected to a ground plane, the first internal electrode 240 may act as the ground plane.

The second internal electrodes 251, 252 and 253 each having a predetermined area may be formed on the second dielectric sheet 212, not on the first dielectric sheet 211 on which the first internal electrode 240 is formed. By laminating the first and second dielectric sheets 211 and 212, the first internal electrode 240 may alternate with the second internal electrodes 251, 252 and 253, having a dielectric sheet therebetween.

According to the current embodiment, three second internal electrodes 251, 252 and 253 may be provided. The second internal electrodes 251, 252 and 253 may be connected to the second external electrodes 231, 232 and 233 through leads, respectively.

According to the current embodiment, the first dielectric sheet 211 may be laminated on the second dielectric sheet 212.

In this case, capacitive coupling may occur between the first internal electrode 240 and the three second internal electrodes 251, 252 and 253. The magnitude of the capacitive coupling may be varied according to areas of the second internal electrodes 251, 252 and 253.

As for a manufacturing process, before lamination of dielectric sheets, a first internal electrode having a predetermined area may be formed on a surface of the first dielectric sheet, and second internal electrodes each having a predetermined area may be formed on a surface of the second dielectric sheet. Thereafter, the first and second dielectric sheets are laminated to form a ceramic body. Then, a first external electrode and second external electrodes may be formed on side surfaces of the ceramic body.

If the laminated ceramic capacitor is used for a specific purpose such as a power smoothing circuit or noise attenuation, the first external electrode 220 may be connected to a ground plane.

For example, in the case where the laminated ceramic capacitor is used for a power smoothing circuit, the first external electrode 220 may be connected to a ground part of, e.g., a substrate in mounting the laminated ceramic capacitor according to the current embodiment on the substrate. The three second external electrodes 231, 232 and 233 may be respectively connected to different power sources.

In the case of the related art laminated ceramic capacitor, three related art laminated ceramic capacitors for power smoothing must be used and connected to three lines, respectively. According to the current embodiment, the same circuit may be implemented by using one laminated ceramic capacitor. That is, according to the current embodiment, miniaturization can be achieved by forming only one pad connected to a common ground plane.

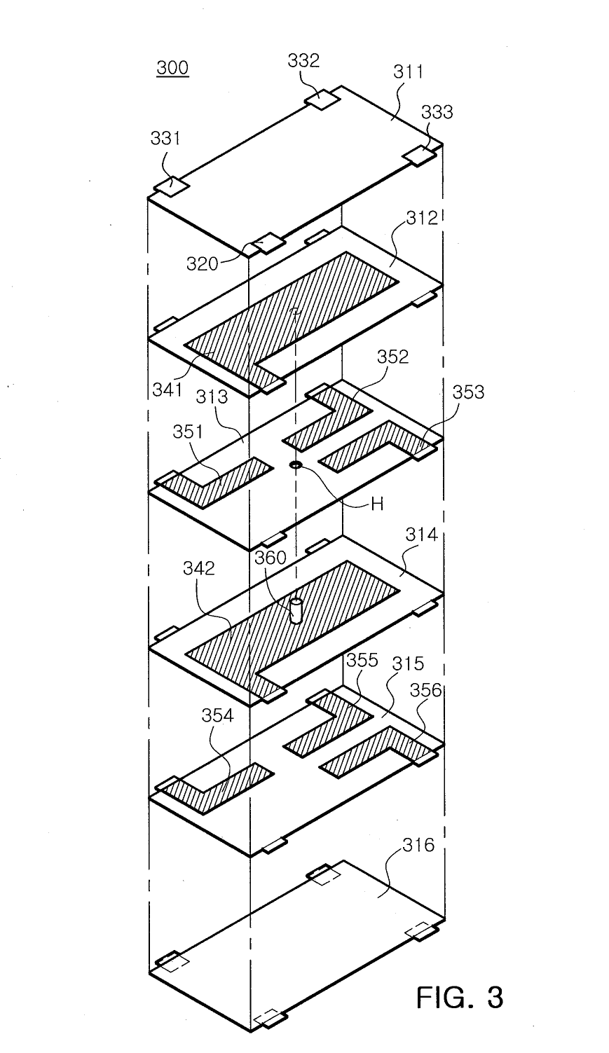

FIG. 3 is an exploded perspective view of a laminated ceramic capacitor 300 according to another embodiment of the present invention.

Referring to FIG. 3, the laminated ceramic capacitor 300 may include a plurality of dielectric sheets 311, 312, 313, 314, 315 and 316 (hereinafter, respectively referred to as first to sixth dielectric sheets), a first external electrode 320, second external electrodes 331, 332 and 333, first internal electrodes 341 and 342, second internal electrodes 351, 352, 353, 354, 355 and 356, and a conductive via 360.

The first to sixth dielectric sheets 311, 312, 313, 314, 315 and 316 may be laminated to form a ceramic body. The first and sixth dielectric sheets 311 and 316 may be a top surface and a bottom surface of the ceramic body, respectively. The first internal electrodes 341 and 342 may be formed on the second and fourth dielectric sheets 312 and 314, respectively. The second internal electrodes 351, 352 and 353 may be formed on the third dielectric sheet 313, and the other second internal electrodes 354, 355 and 356 may be formed on the fifth dielectric sheet 315. However, the number of laminated dielectric sheets of the ceramic body of the laminated ceramic capacitor 300 is not limited to the description, and may be varied.

The first to sixth dielectric sheets 311, 312, 313, 314, 315 and 316 each may be a ceramic sheet having a predetermined dielectric constant.

The first external electrode 320 may be formed on aside surface of the ceramic body in a lamination direction of the first to sixth dielectric sheets 311, 312, 313, 314, 315 and 316. The first external electrode 320 may extend to a top surface and a bottom surface of the ceramic body, so that contact can be facilitated in mounting the laminated ceramic capacitor according to the current embodiment on, e.g., a substrate.

According to the current embodiment, the first external electrode 320 may be formed on a surface of the ceramic body by using a conductive material.

The second external electrodes 331, 332 and 333 may be formed on side surfaces of the ceramic body along the lamination direction of the first to sixth lamination sheets 311, 312, 313, 314, 315 and 316. The second external electrodes 331, 332 and 333 each may extend to the top surface and the bottom surface of the ceramic body, so that contact can be facilitated in mounting the laminated ceramic capacitor according to the current embodiment on, e.g., a substrate.

According to the current embodiment, three second external electrodes 331, 332 and 333 may be provided.

According to the current embodiment, the first external electrode 320 and the second external electrodes 331, 332 and 333 may be formed adjacent to both ends of facing side surfaces of the ceramic body. A location of each of the first and second external electrodes 320, 331, 332 and 333 may be varied according to a location of a pad formed at, e.g., a substrate on which the laminated ceramic capacitor according to the current embodiment is to be mounted.

The first internal electrodes 341 and 342 having a predetermined area may be formed on surfaces of the second and fourth dielectric sheets 312 and 314, respectively.

The first internal electrodes 341 and 342 may be connected with the first external electrode 320 through respective leads. According to the current embodiment, if the first external electrode 320 is connected to a ground plane, the first internal electrodes 341 and 342 may act as ground planes.

One set of three second internal electrodes 351, 352 and 353 may be formed on the third dielectric sheet 313, and the other set of three second internal electrodes 354, 355 and 356 may be formed on the fifth dielectric sheet 315. By laminating the first to sixth dielectric sheets 311 to 316, the first internal electrodes 341 and 342 alternate with the sets of the second internal electrodes 351, 352 and 353 and 354, 355 and 356, having the respective dielectric sheets 312, 313, 314 therebetween.

According to the current embodiment, one set of three second internal electrodes 351, 352 and 353 and the other set of three second internal electrodes 354, 355 and 356 may be formed on different layers. The second internal electrodes 351, 352 and 353 on the third dielectric sheet 313 may be connected to the second external electrodes 331, 332 and 333 through leads, respectively. Also, the other set of second internal electrodes 354, 355 and 356 on the fifth dielectric sheet 315 may be connected to the second external electrodes 331, 332 and 333 through leads, respectively.

According to the current embodiment, the first to sixth dielectric sheets 311 to 316 may be sequentially laminated.

In this case, capacitive coupling may occur between the first internal electrode 341 on the second dielectric sheet 312 and each of the three second internal electrodes 351, 352 and 353 on the third dielectric sheet 313. The capacitive coupling may also occur between each of the three second internal electrodes 351, 352 and 353 on the third dielectric sheet 313 and the first internal electrode 342 on the fourth dielectric sheet 314. The capacitive coupling may occur between the first internal electrode 342 on the fourth dielectric sheet 314 and each of the three second internal electrodes 354, 355 and 356 on the fifth dielectric sheet 315. As described above, the capacitive coupling occurs between the first internal electrodes 341 and 342 and the second internal electrodes 351, 352, 353, 354, 355 and 356, having the dielectric sheets 312, 313 and 314 therebetween. The magnitude of the capacitive coupling may be varied according to areas of the second internal electrodes 351, 352, 353, 354, 355 and 356 overlapping the first internal electrodes 341 and 342.

As for a manufacturing process, a first internal electrode or second internal electrodes having a predetermined area is formed on each of surfaces of a plurality of dielectric sheets before lamination of the dielectric sheets. Thereafter, the plurality of dielectric sheets are laminated on top of each other to form a ceramic body, and then first and second external electrodes may be formed on side surfaces of the ceramic body.

The first internal electrodes formed on different dielectric sheets may be connected with each other by a conductive via 360.

According to the current embodiment, the conductive via 360 may be formed, passing through the second dielectric sheet 312 and the third dielectric sheet 313. The first internal electrode 341 on the second dielectric sheet 312 and the first internal electrode 342 on the fourth dielectric sheet 314 may be connected with each other by the conductive via 360.

The first internal electrode 341 on the second dielectric sheet 312 and the first internal electrode 342 on the fourth dielectric sheet 314 may have the same polarity by being individually connected to the first external electrode 320. However, a current distribution varies in each of the first internal electrodes 341 and 342 according to a distance from the first external electrode 320, which also varies the magnitude of the capacitive coupling with the corresponding second internal electrodes 351, 352, 353, 354, 355 and 356. The current distribution variation within the first internal electrodes 341 and 342 can be reduced by connecting the first internal electrodes 341 and 342 with each other.

According to the current embodiment, the conductive via 360 may be separated from the three second internal electrodes 351, 352 and 353 on the third dielectric sheet 313 at the same distance. That is, a via hole H for the conductive via 360 in the third dielectric sheet 313 may be separated from the second internal electrodes 351, 352 and 351 at the same distance.

When the laminated ceramic capacitor according to the current embodiment is used for a specific purpose such as a power smoothing circuit or noise attenuation, the first external electrode 320 may be connected to a ground plane.

For example, in the case of the laminated ceramic capacitor for power smoothing, the first external electrode 320 may be connected to a ground part such as a substrate, and the three second external electrodes 331, 332 and 333 may be connected to respectively different power sources.

In the case of a related art laminated ceramic capacitor, three related art laminated ceramic capacitors for power smoothing must be used to be respectively connected to three lines. However, according to the current embodiment, the same circuit can be implemented by using one laminated ceramic capacitor. According to the current embodiment, miniaturization can be achieved by forming only one pad connected to a common ground plane.

According to the embodiments of the present invention, one laminated ceramic capacitor has a structure in which a plurality of laminated ceramic capacitors are arranged, so that high degree of integration and miniaturization of an electronic component employing the same can be achieved.

While the present invention has been shown and described in connection with the exemplary embodiments, it will be apparent to those skilled in the art that modifications and variations can be made without departing from the spirit and scope of the invention as defined by the appended claims.

What is claimed is:

1. A laminated ceramic capacitor comprising:
a ceramic body having a structure in which a plurality of dielectric sheets are laminated;
a first external electrode formed outside the ceramic body;
at least two second external electrodes formed outside the ceramic body, separated from the first external electrode and having a polarity that is different from that of the first external electrode;
a first internal electrode formed on one surface of at least one laminated dielectric sheet; and
at least two second internal electrodes respectively connected to the at least two second external electrodes through a lead, the second internal electrodes forming capacitive coupling with the first internal electrode, having the at least one dielectric sheet therebetween.

2. The laminated ceramic capacitor of claim 1, wherein the first external electrode is connected to an external ground plane.

3. The laminated ceramic capacitor of claim 1, wherein the second external electrodes comprise three second external electrodes.

4. The laminated ceramic capacitor of claim 3, wherein the first external electrode and the second external electrodes are formed on side surfaces of the ceramic body to face each other, the side surfaces being formed in a direction in which the dielectric sheets are laminated.

5. The laminated ceramic capacitor of claim 3, wherein the second internal electrodes respectively connected to the second external electrodes have the same area.

6. The laminated ceramic capacitor of claim 1, wherein the first external electrode and the second external electrodes are formed on side surfaces of the ceramic body, the side surfaces being formed in a direction in which the dielectric sheets are laminated.

7. The laminated ceramic capacitor of claim 6, wherein the first external electrode and the second external electrodes each have portions respectively extending to a top surface and a bottom surface of the ceramic body.

8. The laminated ceramic capacitor of claim 1, wherein the first internal electrode comprises a plurality of first internal electrodes formed on the respective different dielectric sheets,
wherein the laminated ceramic capacitor further comprises a conductive via passing through the dielectric sheets between the first internal electrodes to connect the first internal electrodes respectively formed on the different dielectric sheets.

9. The laminated ceramic capacitor of claim 8, wherein the conductive via is separated from the at least two second internal electrodes formed on the dielectric sheet at the same distance.
